(19) United States
(12) Patent Application Publication
(10) Pub. No.: US 2024/0247738 A1
(43) Pub. Date: Jul. 25, 2024

(54) FLEXIBLE UNDERWATER PIPE COMPRISING A WEAR-RESISTANT POLYPROPYLENE HOMOPOLYMER LAYER

(71) Applicant: TechnipFMC Subsea France, COURBEVOIE (FR)

(72) Inventors: Demanze FREDERIC, CAUDEBEC EN CAUX (FR); Julien MAURICE, DUCLAIR (FR)

(21) Appl. No.: 18/562,661

(22) PCT Filed: May 19, 2022
(86) PCT No.: PCT/EP2022/063552

§ 371 Date: Nov. 20, 2023

(30) Foreign Application Priority Data
May 21, 2021 (FR) 21 05325

(51) Int. Cl. F16L 11/08; F16L 11/04

(52) U.S. Cl. CPC F16L 11/083; F16L 2011/047

(57) ABSTRACT

A flexible underwater pipe for hydrocarbon transport that includes at least two reinforcement layers separated by a wear-resistant layer of polymeric material, each of said reinforcing layers being produced by helically winding a longitudinal element made of metal or a composite material, said wear-resistant layer being produced by helically winding at least one strip of said polymeric material, the polymeric material including a specific polypropylene homopolymer.

The present invention relates to an underwater pipe for the transport of fluids, more particularly of hydrocarbons.

Most flexible pipes used in the offshore oil industry are flexible pipes, generally including, from the inside to the outside:
if appropriate, a metal carcass,
an inner polymeric sealing sheath,
at least one reinforcement layer consisting of a helical winding of a longitudinal element made of metal or of composite material around the inner sealing sheath,
an outer polymeric sealing sheath.

Typically, the pipes include, from the inside to the outside:
if appropriate, a metal carcass,
an inner polymeric sealing sheath,
if appropriate, a pressure vault,
at least one layer of tensile armor (generally two layers of tensile armor),
an outer polymeric sealing sheath.

Hereinafter, the terms “outer” or “external” and “inner” or “internal” are understood as being farther radially from the axis of the flexible pipe and as being closer radially to the axis of the flexible pipe, respectively.

The pipes are generally of the unbonded type. The term “unbonded” means that the layers are free to move with respect to each other. Typically, the adjacent layers are not bonded together, welded together, and they are not embedded in a polymeric or elastomeric sheath.

Such flexible pipes are described in particular in the normative document API 17J, “Specification for Unbonded Flexible Pipe”, 4th edition, May 2014 published by the American Petroleum Institute. Same are used in particular in deep water in the oil and gas industry. Typically, flexible pipes are used for the transport of fluids, in particular hydrocarbons, or for the reinjection of carbon dioxide into an underwater reservoir. Oil-transporting flexible pipes generally extend through a body of water between a surface unit and a bottom unit. Such pipes can also extend between two surface units or between two bottom units.

The bottom assembly is intended for collecting the fluid involved in the bottom of the body of water, to monitor and control the flow thereof and to distribute the fluid to the surface unit. The surface unit is generally a floating unit. Same is intended for collecting, potentially treating, and distributing the fluid. The surface unit can be a semi-submersible platform, an FPSO or another floating unit.

In some cases, for the dealing with fluids in deep water, the flexible pipe has a length greater than 800 m, or even greater than 1000 m or than 2000 m for ultra-deep water applications.

For great depths, the flexible pipe is dimensioned to withstand a very high hydrostatic pressure, typically from 50 to 1000 bar, e.g. 200 bar for a pipe immersed at a depth of 2000 m and at high temperatures, above 130° C., or even 170° C., for long periods of time, i.e. several of years, typically 20 years.

In addition, the flexible pipe is typically designed for withstanding an axial tension greater than the total weight of the flexible pipe suspended from a surface unit and extending underwater from the surface to the seabed. Such is particularly the case when the flexible pipe is used as a riser intended for providing, in service, a vertical connection between the seabed and the surface unit. The ability of the flexible pipe to support its own weight thereof when suspended in water makes the installation thereof easier at sea from a laying vessel.

However, such flexible pipes generally have a high weight, which makes the installation thereof in deep and ultra-deep water, complex and expensive. In addition, risers of such type generally have to be equipped with buoys for applications at great depth, which entails additional expenses. Finally, the reinforcement metal layers are generally sensitive to corrosion, in particular to corrosion under the influence of acid gases such as H₂S and CO₂ present in the hydrocarbons of certain deposits. Reinforcement layers made of composite material are sometimes likely to degrade in the presence of water (hydrolysis in particular), the degradation being exacerbated by H₂S.

To overcome such problems, lightweight flexible pipes comprising a tubular reinforcement structure made of composite material comprising a thermoplastic matrix and reinforcement fibers embedded in the matrix have been developed, namely so-called hybrid flexible pipes (HFP).

In the so-called “hybrid” flexible pipes, the metal carcass and the inner polymeric sealing sheath of the flexible pipe described hereinabove are replaced by a thermoplastic composite pipe (TCP), as described in the normative document DNVGL-ST-F119 “Thermoplastic Composite pipe”, September 2019 issue published by Det Norsk Veritas. The so-called “hybrid” flexible pipes include, from the inside to the outside:
a tubular inner polymeric sheath,
a tubular reinforcement structure made from a winding of a plurality of strips of composite material, the intermediate layer being bonded to the tubular inner polymeric sheath,
a polymeric sealing sheath,
at least one reinforcement layer consisting of a helical winding of a longitudinal element made of metal or of composite material around the inner sealing sheath,
an outer polymeric sealing sheath.

“Bonded” means that the tubular reinforcement structure and the tubular inner polymeric sheath are not free to move with respect to each other. Same can be bonded by gluing (by means of glue or an adhesive) or by welding.

The tubular reinforcement structure generally takes up most of the radial forces applied to the hybrid flexible pipe. The tubular reinforcement structure, bonded to the tubular polymeric inner sealing sheath, has a further barrier function against gases, such as acid gases like H₂S and CO₂ contained in the hydrocarbons transported inside the tubular polymeric inner sealing sheath. Thereby, same protects the metal reinforcement elements of the flexible pipe against corrosion phenomena and/or the composite material from a deterioration by hydrolysis.

The reinforcement layer or layers consisting of wires made of metal or of composite material are similar to the layers of unbonded flexible pipes, i.e. same consist of helically wound wires or strips, generally along a long pitch. The layers are generally not bonded to adjacent layers. The layers are generally tensile armor layers.

Furthermore, optionally, the hybrid flexible pipes can include an inner carcass situated inside the tubular polymeric inner sheath, the function of said inner carcass being to increase the resistance to collapse of the pipe. The inner carcass is formed, e.g., by a profiled metal strip, wound in a spiral. The turns of the strip are advantageously interlocked, which makes it possible to take up the crushing forces.

Such hybrid flexible pipes are described in particular in the article “Unbonded Flexible Pipe: Composite reinforcement for Optimized Hybrid Design” written by N. Dodds, V. Jha, J. Latto and D. Finch, and published as OTC-25753 at the “Offshore Technology Conference” held in Houston from 4 to 7 May 2015 or in the applications GB 2 504 065 and WO 2018/091693. The two applications describe hybrid flexible pipes wherein the tubular reinforcement structure is produced from a winding of a plurality of strips comprising a polymeric matrix and wherein reinforcement fibers are embedded.

Whether the flexible pipe is a “usual” unbonded pipe or a hybrid flexible pipe, the different unbonded layers are, within a certain limit, movable with respect to one another, so as to allow the flexible pipe to bend. When the pipe comprises a plurality of adjacent reinforcement layers of metal or composite material, such mobility induces friction between the reinforcement layers and the adjacent layers, and ultimately leads to the premature wear thereof.

Thereby, in order to prevent at least two of the metallic or composite reinforcement layers from being directly in contact with each other, which would cause the wear thereof, an intermediate layer of polymeric material, called an “anti-wear layer”, may be interposed.

The anti-wear intermediate layer can however deteriorate rapidly when the flexible pipe is subjected to severe stresses, such as the stresses encountered for the exploitation of certain underwater oil deposits, located at great depth, and where the hydrocarbon is at a high temperature greater than 130° C., and/or in the case of severe dynamic conditions (variations of the flexible pipe bends). Under such conditions, the anti-wear intermediate layer can withstand temperatures close to 110° C. and contact pressures on the order of 300 to 400 bar. One of the most common deteriorations is a loss of thickness of the anti-wear layer by creep, which can limit or even destroy the protection imparted by the anti-wear layer on adjacent reinforcement layers.

Application WO 2006/120320 describes a flexible pipe for transporting hydrocarbons comprising an anti-wear layer of amorphous polymer, preferentially polysulfone (PSU), polyethersulfone (PES), polyphenylsulfone (PPSU) or polyetherimide (PEI).

The use of thermoplastic materials in unbonded flexible pipes is summarized in the standard documents API RP 17B ((2014) and API 17J (2014) published by the American

### Petroleum Institute.

The literature reports the use of polypropylene as a polymeric material for polymeric layers of a flexible pipe.

For example, application WO 2017/174660 describes an underwater pipe intended for transporting hydrocarbons comprising a metal reinforcement layer around an inner polymeric sealing sheath likely to be in contact with the hydrocarbons and comprising a polypropylene homopolymer with specific density and melt flow index. However, the inner polymeric sealing sheath is not an anti-wear layer (and vice versa). An anti-wear layer does not come into contact with hydrocarbons when the pipe is commissioned.

Application WO 2017/076412 describes an underwater pipe intended for transporting hydrocarbons comprising a polymeric layer comprising at least 50% by weight of a polypropylene and at least 1% by weight of a plastomer formed from a propylene and at least one comonomer other than propylene. However, such application does not suggest either a polypropylene homopolymer having the flexural modulus and the melt flow index defined hereinbelow for same used in the present invention, nor the improved creep behavior making the use thereof advantageous as an anti-wear layer. Furthermore, the presence of the plastomer is required in order to impart the required strength and flexibility to the layer, in non-negligible proportions. Such a plastomer considerably increases the retail price of the layer.

One of the goals of the present invention is to provide an underwater pipe for the transport of fluid, preferentially hydrocarbons, the anti-wear layer of which is less expensive and which has a creep resistance such that the anti-wear layer retards, preferentially prevents the wear of the metal or composite reinforcement layers surrounding same, throughout the entire life of the pipe, typically 20 years.

To this end, according to a first subject matter, the invention relates to a flexible underwater pipe for the transport of fluid, preferentially of hydrocarbons, comprising at least two reinforcement layers separated by an anti-wear layer made of polymeric material, each of said reinforcement layers being produced by helically winding a longitudinal element of metal or of composite material, said anti-wear layer being produced by helically winding at least one strip of said polymeric material, the polymeric material comprising a polypropylene homopolymer having:
a flexural modulus measured at 23° C., according to the ISO 178 standard of 2019, greater than 1500 MPa, and
a melt flow index (MI or MFI) measured according to ISO 1133, revised in 2011, to 230° C. under a weight of 2.16 kg less than or equal to 4.0 g/10 minutes.

The invention is based on the discovery that such a polypropylene homopolymer has a creep resistance which allows the anti-wear layer formed from a strip containing same to maintain a sufficient thickness so that the reinforcement layers surrounding same do not come into contact, and hence do not wear against each other. The use of such a polypropylene homopolymer reduces the loss of thickness of the anti-wear layer, which is advantageous because the more the thickness of the anti-wear layer is maintained, the better same protects the reinforcement layers that surround the anti-wear layer.

Moreover, such a polypropylene homopolymer withstands the pressure and temperature conditions mentioned hereinabove. In addition, same has a chemical resistance compatible with the use thereof as a polymeric material of a layer of a flexible pipe for the transport of hydrocarbons. The annular space (space between the inner polymeric sheath and the outer polymeric sheath for sealing the pipe) in which the anti-wear layer is located, comprises gases and/or acids (more particularly, CO₂ and H₂S). Advantageously, polypropylene homopolymer is not sensitive to hydrolysis, unlike a polyamide anti-wear layer. Furthermore, the polypropylene homopolymer is not very sensitive, even not sensitive, to the plasticization induced by CO₂.

Another of the advantages of such an anti-wear layer is that the polypropylene homopolymer has a good permeability to CO₂ and to H₂S, which makes it possible to reduce the concentration of CO₂ and H₂S in the layers more internal than the anti-wear layer, and hence to reduce the corrosion (more particularly for the metal layers) and/or the deterioration under hydrolysis (more particularly for the polymer or composite layers) of the more internal layers.

Another of the advantages of such an anti-wear layer is the low cost thereof.

The polymeric material of the helically wound strip for forming the anti-wear layer of the pipe comprises a polypropylene homopolymer or a mixture of polypropylene homopolymers.

There are three main classes of polypropylene, namely homopolymers (PPH), block copolymers (also called “impact copolymer”) (PPB) and random copolymers (PPR) (names according to ISO 15013 revised in 2015 and ISO 1873-2 revised in 2011). Typically, the PPH consist of at least 97%, especially at least 98%, typically at least 99%, preferentially at least 99.8% and advantageously exclusively of a chain of propylene units with respect to the total number of units. The proportion of propylene units can in particular be determined by Fourier transform infrared spectroscopy.

The polypropylene homopolymer of the polymeric material of the strip has a flexural modulus measured at 23° C. according to ISO standard 178 of 2019 at a flexural deformation rate of 1%. min⁻¹ greater than 1500 MPa, in particular greater than or equal to 1550 MPa, preferentially greater than or equal to 1600 MPa, particularly preferentially greater than or equal to 1700 MPa. The flexural modulus is generally less than 2500 MPa, in particular less than 2300 MPa, preferentially less than 2100 MPa. The flexural moduli are particularly suitable for the anti-wear layer to have the creep resistance required in order to make it possible to reduce the reduction in the thickness thereof.

The polypropylene homopolymer of the polymeric material of the strip has a melt flow index measured according to ISO 1133 revised in 2011 to 230° C. under a weight of 2.16 kg less than or equal to 4.0 g/10 minutes. The melt flow index is generally greater than 0.1 g/10 minutes, in particular greater than 0.3 g/10 minutes, preferentially greater than or equal to 2.0 g/10 minutes. Such melt flow indices facilitate the preparation of a strip by extrusion. The use of polypropylene homopolymer with a higher melt flow index generally leads to strips the thickness of which is not sufficiently homogeneous, which is detrimental to the homogeneity of the thickness of the anti-wear layer obtained and hence to the performance thereof.

When the polymeric material comprises a mixture of polypropylene homopolymers, it is not mandatory that each polypropylene homopolymer same contains has a flexural modulus and a melt flow index as defined above. It is indeed sufficient for the mixture to have such properties. In a particular embodiment, each polypropylene homopolymer of the mixture of polypropylene homopolymers has a flexural modulus and a melt flow index as defined in the present application.

The polypropylene homopolymer of the polymeric material of the strip (or the mixture of polypropylene homopolymers, or even each polypropylene homopolymer of the mixture of polypropylene homopolymers) generally has:
a density as per ISO 1183 of 2019 greater than or equal to 0.85 g/cm³, typically or equal to 0.88 g/cm³, in particular or equal to 0.905 g/cm³,
a tensile yield stress measured at 23±2° C. and with a displacement speed of 50 mm/minute according to ASTM D638 type IV of 2014 or ISO 527-2 of 2012, comprised between 30 and 45 MPa, and/or
an elongation at yield (measured at 23±2° C. and with a displacement speed of 50 mm/min according to ASTM D638 of 2014 or ISO 527-2 of 2012) of 1 to 7%, preferentially of 3 to 5%.

The polypropylene homopolymer of the polymeric material of the strip (or each polypropylene homopolymer of the mixture of polypropylene homopolymers) generally has a melting temperature (considering the peak corresponding to the highest melting temperature in differential scanning calorimetry (DSC) according to the 2018 ISO 11357-3 standard), at least equal to 150° C., in particular at least equal to 200° C., preferentially at least equal to 220° C. Generally, there is a coexistence of alpha and beta crystalline morphologies in polypropylene homopolymer, which can lead to two distinct melting peaks in DSC. In such case, the peak corresponding to the highest melting temperature is taken into account within the framework of the application.

Polypropylene homopolymer (or the mixture of polypropylene homopolymers, or even each polypropylene homopolymer of the mixture of polypropylene homopolymers) generally has a degree of crystallinity of at least 40%, typically at least 50%. The level of crystallinity can be calculated by dividing the heat of fusion of polypropylene homopolymer determined by differential scanning calorimetry by the melting heat of a 100% crystalline polypropylene homopolymer, generally estimated at 207 joules/grams.

Such density, tensile yield stress, elongation at yield, melting temperature and degree of crystallinity contribute to the fact that the polypropylene homopolymer has an improved creep resistance and is compatible with the use of the strip of polymeric material comprising the polypropylene homopolymer as an anti-wear layer between two layers of metallic or composite reinforcements in a pipe for the transport of fluids, preferentially of hydrocarbons.

Examples of polypropylene homopolymer exhibiting such properties include the following polypropylene homopolymers: Repsol PP040C1E, Polychim HL10XF, LyondellBasell Moplen HP740J, Braskem inspire 234, Total PPH4022 and Braskem H605.

The polypropylene homopolymer of the strip (or one of, even each, polypropylene homopolymer of the mixture of polypropylene homopolymers) can be cross-linked.

The polypropylene homopolymer of the strip (or one of, even each, polypropylene homopolymer of the mixture of polypropylene homopolymers) can be not cross-linked.

Embodiments are described hereinafter for the strip and the polymeric material. Same apply for at least one strip, preferentially for each strip, when the anti-wear layer comprises a plurality of strips.

The strip comprising the polypropylene homopolymer defined hereinabove typically comprises:
a polymeric matrix, and
if appropriate, components dispersed discontinuously in the polymer matrix.

The term “polymeric matrix” means the polymeric continuous phase which forms the strip. The polymeric matrix is a continuous matrix. The polymeric material of the strip can comprise, if appropriate, components discontinuously dispersed in the polymeric matrix but which are not part of the polymeric matrix. Such components can be e.g. fillers such as fibers.

The polymeric matrix of the polymeric material of the strip is generally obtained by extrusion of one or a plurality of polymers (which will form the polymeric matrix) and, if appropriate, additives (masterbatch). During extrusion, some additives are incorporated into the polymer matrix, whereas other additives do not mix with the polymers forming the polymer matrix and disperse discontinuously in the polymer matrix, in order to form discontinuously dispersed components in the polymeric matrix.

According to a first alternative, the polymeric material of the strip has a polymeric matrix which comprises a polypropylene homopolymer as defined hereinabove.

According to such alternative, the polymeric material of the strip the polymeric matrix of which comprises the polypropylene homopolymer is generally obtained by extrusion of one or a plurality of polymers (which will form the polymeric matrix), at least one of same being the polypropylene homopolymer defined hereinabove, and, if appropriate, in the presence of additives.

The components dispersed discontinuously in the polymeric matrix can, if appropriate, comprise polymers, e.g. a polypropylene homopolymer as defined hereinabove. However, a pipe:
in which the polymeric material of the strip of the anti-wear layer comprises a component discontinuously dispersed in the polymeric matrix (in particular fillers such as fibers) comprising or consisting of a polypropylene homopolymer as defined hereinabove,
but in which the polymeric matrix is free of polypropylene homopolymer as defined hereinabove,
   does not meet the definition of a pipe comprising an anti-wear layer produced by helically winding at least one strip of polymeric material the polymeric matrix of which comprises a polypropylene homopolymer as defined hereinabove, as defined in the first alternative.

According to a second alternative, the polymeric material of the strip comprises a component dispersed discontinuously in the polymeric matrix, said component comprising a polypropylene homopolymer as defined hereinabove.

According to the second alternative, a component dispersed discontinuously in the polymeric matrix of the polymeric material of the strip comprises a polypropylene homopolymer as defined hereinabove. The component can be a filler such as a fiber. The component comprising a polypropylene homopolymer as defined hereinabove is generally one of the additives of the masterbatch used during extrusion. According to the second alternative, the polymeric matrix of the polymeric material of the strip can be free of polypropylene homopolymer as defined hereinabove.

According to a third alternative, the polymeric material of the strip comprises a component dispersed discontinuously in the polymeric matrix, said component comprising a polypropylene homopolymer as defined hereinabove and the polymeric matrix thereof comprises a polypropylene homopolymer as defined hereinabove.

According to the third alternative, the polypropylene homopolymer as defined hereinabove is thus present both in the polymeric matrix and in a component dispersed discontinuously in the polymeric matrix.

The polymeric material of each strip preferentially comprises at least 50% by weight, in particular at least 65% by weight, preferentially at least 75% by weight, typically at least 85% by weight, e.g. at least 90% by weight, in a particularly preferred manner, at least 95% by weight of polypropylene homopolymer as defined hereinabove with respect to the weight of the strip. Advantageously, the properties of the polypropylene homopolymer as defined hereinabove make it possible to use only little, or even no modifier.

The strip can comprise a plasticizer, which improves the performance of the cold anti-wear layer (by means of the lowering of the glass transition temperature by 10° C., or even 25° C., measurable by dynamic mechanical analysis (DMA). The plasticizer can e.g. be chosen from the compounds defined in the Handbook of Plasticizers published by Georges Wypych. The plasticizer can e.g. be chosen from liquid saturated hydrocarbons (such as Primol 542 from ExxonMobil), isooctyl monoester tallate (such as PLASTHALL® 100 from Hallstar Industrial), dioctyl sebacate, paraffin oil or a mixture thereof.

For example, the polymeric material of the strip comprises from 0% to 5% by weight of plasticizer.

The polymeric material of the strip can also comprise an impact modifier, which makes it possible to improve the cold behavior thereof, in particular the resistance thereof to cold brittleness. Thereby, the polymeric material of the strip can comprise from 0 to 5% by weight, with respect to the total weight of the strip, of an impact modifier, generally a polymer having a flexural modulus of less than 100 MPa, measured according to the 2019 ISO 178 standard. The impact modifier preferentially consists of one or a plurality of polyolefins. For example, the polyolefin is chosen from: an ethylene-propylene copolymer with elastomeric character (EPR), an ethylene-butene copolymer (EBR), an ethylene-octene copolymer (EOR), an ethylene-propylene-diene copolymer with elastomeric character (EPDM), a styrene-butadiene copolymer (SBR) an and ethylene/alkyl(meth)acrylate copolymer, preferentially chosen from an ethylene-butene copolymer (EBR) an ethylene-octene copolymer (EOR), a styrene-butadiene copolymer (SBR) and an ethylene/alkyl(meth)acrylate copolymer.

Preferentially, the polymeric material of the strip comprises less than 0.4%, in particular less than 0.1% with respect to the weight of the strip, or is even free of plastomer formed from a propylene and at least one comonomer other than propylene. In addition to polypropylene homopolymer (or mixture of polypropylene homopolymers), the polymeric material of the strip comprising less than 0.4%, in particular less than 0.1% with respect to the weight of the strip, or even being free of copolymer of polypropylene and one or a plurality of other monomers. A polypropylene copolymer typically contains less than 95%, typically less than 90%, of propylene units with respect to the total number of units in the polypropylene copolymer. The proportion of propylene units can in particular be determined by Fourier transform infrared spectroscopy.

The polymeric material of the strip can comprise less than 10%, in particular less than 5% with respect to the weight of the strip or can even be free of polyolefin other than polypropylene homopolymer (or the mixture of polypropylene homopolymers). Same can comprise less than 10%, in particular less than 5% with respect to the weight of the strip, or even be free of polymer other than polypropylene homopolymer (or the mixture of polypropylene homopolymers).

The polymeric material of the strip can comprise one or a plurality of other additives, in particular chosen from antioxidants, anti-UV agents, reinforcement fillers, manufacturing admixtures, heat stabilizers (e.g. a stabilizer from the BRUGGOLEN® H range from Brüggemann), nucleating agents and a mixture thereof, preferentially chosen from antioxidants, nucleating agents and a mixture thereof. Thereby, the polymeric material of the strip can comprise from 0 to 10% by weight, preferentially from 0 to 5% by weight, of additive or mixture thereof with respect to the total weight of the strip.

Typically, the polymeric material of the strip comprises, or even consists of:
80 to 100% by weight, preferentially from 90 to 100% by weight, of polypropylene homopolymer as defined hereinabove or of a mixture thereof,
0 to 5% by weight of plasticizer,
0 to 5% by weight of impact modifier,
0 to 10% by weight of additives.

The strip may be multi-layered, e.g. bi- or tri-layered. Preferentially, the strip is a single-layer.

Generally, the strip has a cross-section with rectangular shape, or close to a rectangular shape. Preferentially, the strip has a thickness of 0.1 to 5.0 mm, preferentially of 0.5 to 3.0 mm and/or a width of 30 to 200 mm, preferentially of 40 to 150 mm. The length of the strip varies and can be up to 5 km long.

The pipe comprises at least two reinforcement layers, each of which is produced by helically winding a longitudinal element made of metal or of composite material. The anti-wear layer is surrounded by the two reinforcement layers. Same can be either adjacent or non-adjacent to the latter.

Generally, each of the two reinforcement layers is produced by helically winding a longitudinal element with a long pitch. In the present application, the notion of short-pitch winding denotes any helical winding along a helix angle close to 90°, typically comprised between 75° and 90°. The concept of long-pitch winding covers helix angles of less than 60°, typically comprised between 20° and 60° for the reinforcement layers. Generally, each of the two reinforcement layers is unbonded to the adjacent polymeric layers. “Unbonded” means that the reinforcement layers are free to move with respect to the adjacent polymeric layers (in particular with respect to the wear layer). Typically, the reinforcement layers of the flexible pipe are not embedded in a polymeric or elastomeric sheath (more particularly in the wear layer). Similarly, there is preferentially no adhesive between the reinforcement layers and the adjacent polymeric layer(s) (more particularly the wear layer).

According to a first alternative, the flexible pipe comprises an inner polymeric sealing sheath, within which the fluid to be transported flows). The latter can be made of polyamide, PVDF, polyethylene, in particular high molecular weight polyethylene or polyethylene with increased strength, or polypropylene, in particular polypropylene homopolymer or polypropylene copolymer. The inner polymeric sealing sheath of the flexible pipe is typically tubular. Same generally has a diameter of 50 mm to 600 mm, preferentially of 50 to 400 mm, and/or a thickness of 1 mm to 150 mm, preferentially of 4 to 15 mm and/or a length of 1 m to 10 km.

The pipe can further comprise a metal carcass. If the pipe comprises a metal carcass, the pipe is called a rough-bore pipe. If the pipe has no metal carcass, the pipe is called a smooth-bore pipe.

The main function of the metal carcass is to take up the radial forces directed from the outside to the inside of the pipe in order to prevent the collapse of all or part of the pipe under the effect of such forces. Such forces are related in particular to the hydrostatic pressure exerted by the seawater when the flexible pipe is submerged. Thereby, the hydrostatic pressure can reach a very high level when the pipe is submerged at great depth, e.g. 200 bar when the pipe is submerged at a depth of 2000 m, so it is often necessary to equip the flexible pipe with a metal carcass.

When the flexible pipe comprises an outer polymeric sheath, the metal carcass has also the function of preventing the collapse of the inner polymeric sealing sheath during rapid decompression of a flexible pipe that transported hydrocarbons. Indeed, the gases contained in the hydrocarbons diffuse slowly through the inner polymeric sealing sheath and are partly trapped in the annular space between the inner polymeric sealing sheath and the outer polymeric sheath. Consequently, during a production shut-down leading to rapid decompression of the inside of the flexible pipe, the pressure prevailing in the annular space can temporarily become significantly higher than the pressure prevailing inside the pipe, which, in the absence of a metal carcass, would lead to the collapse of the inner polymeric sealing sheath.

Consequently, generally, for the transport of hydrocarbons, a pipe comprising a metal carcass is preferred, whereas a pipe without a metal carcass will be suitable for the transport of water and/or steam under pressure. Furthermore, when the pipe is intended both to transport hydrocarbons and to be immersed at great depth, then the metal carcass becomes indispensable in most applications.

The metal carcass consists of longitudinal elements wound helically with a short pitch. The longitudinal elements are strips or profiled metal wires (generally made of stainless steel) arranged in interlocked turns. Generally, the metal carcass is made by profiling an S-shaped strip and then winding same in a helix so as to staple the adjacent turns together.

The metal carcass is generally coated with the inner polymeric sealing sheath. Since the metal carcass is not adjacent to another reinforcement layer, same is not subject to frictional wear and is thus preferentially not coated with an anti-wear layer.

At least one of the reinforcement layers of the pipe is generally a layer of tensile armor. The main function of the tensile armor layers is to take up the axial forces linked both to the inner pressure prevailing inside the flexible pipe and to the weight of the flexible pipe, particularly when the pipe is suspended. When the pipe has no pressure vault (e.g. in the case of a flexible line of the OOL (Oil Offloading Line) type, the armor layer makes it possible to take up both axial and radial forces. The tensile armor layers are located towards the outside of the pipe. The tensile armor layers are obtained by winding metal wires, with a long pitch, of generally substantially rectangular cross-section, but sometimes with a circular or complex cross-section, e.g. of the self-interlocked T-shape type. The tensile armor layers can alternatively be obtained by winding a longitudinal element made of composite material with a long pitch, e.g. as described in application FR 2 776 358. Such composite material typically comprises a polymer matrix reinforced with carbon fibers, glass fibers, aramid fibers, metal fibers or mineral fibers (e.g. made of basalt).

Generally, the pipe comprises two layers of tensile armor, typically two: an inner layer (the most central layer of the pipe) and an outer layer (the outermost layer of the pipe), and the longitudinal elements thereof being wound by helical windings in opposite directions. The pipe can comprise more than two tensile armor layers, the longitudinal elements of two successive tensile armor layers being wound by helical windings in opposite directions.

One of the reinforcement layers can be a pressure vault. The latter is intended for taking up the radial forces linked to the inner pressure and directed from the inside towards the outside of the pipe, in order to prevent the inner polymeric sheath from bursting under the effect of the pressure prevailing inside the pipe. Usually, the pressure vault is situated towards the inside of the pipe. It is a more inner layer than the layer(s) of tensile armor. The pressure vault consists of longitudinal elements wound with a short pitch, e.g. metal wires in with Z (zeta)-shape, C-shape, T (teta)-shape, U-shape, K-shape, X-shape or I-shape, and/or at least one high-strength aramid strip (Technora® or Kevlar®), and/or at least one composite strip comprising a thermoplastic matrix wherein reinforcement fibers, e.g. carbon fibers or glass fibers, are embedded.

The presence of the pressure vault is not essential, more particularly when the helix angles of the wires forming the tensile armor layers are close to 55°. In fact, such particular helix angle gives the tensile armor layers the capacity to take up, in addition to axial forces, the radial forces exerted on the flexible pipe and directed from the inside towards the outside of the pipe. Preferentially, and in particular for applications at great depth, the flexible pipe comprises a pressure vault.

The flexible pipe typically comprises an outer polymeric sealing sheath for preventing seawater from penetrating into the flexible pipe. As a result, in particular, the tensile armor layers from seawater are protected and hence the phenomenon of corrosion by seawater can be prevented. The outer polymeric sealing sheath is advantageously made of a polymer material, in particular containing a polyolefin, such as polyethylene, containing a polyamide, such as PA11 or PA12, containing a fluorinated polymer such as polyvinylidene fluoride (PVDF), or containing an elastomeric thermoplastic comprising a polyolefin, such as polyethylene or polypropylene, associated with an elastomer such as SBS (styrene butadiene styrene), SEBS (styrene ethylene butadiene styrene), EPDM (ethylene propylene diene monomer), polybutadiene, polyisoprene or polyethylene-butylene.

The flexible pipe can comprise, as reinforcement layer, a reinforcement tape between the outer polymeric sealing sheath and the armor layer (the outermost layer when there is a plurality of armor layers). The reinforcement tape is formed e.g. by an anti-buckling layer with high mechanical strength in order to limit the buckling of the tensile armor layer(s) in the event that the pipe is subject to the phenomenon of reverse end force. Such anti-buckling layer is e.g. made of aramid. The reinforcement tape is wound around the outermost armor layer, advantageously as indicated in API 17J, 4th edition May 2014.

The nature, number, sizing and organization of the layers forming the flexible pipes are essentially related to the conditions of use and installation thereof. The pipes can comprise layers in addition to the aforementioned layers.

The anti-wear layer can be adjacent to and located between the two reinforcement layers. In such case, the anti-wear layer is the only layer between the two reinforcement layers.

Alternatively, there can be one or a plurality of other layers between the two reinforcement layers. For example, there can be, in addition to the anti-wear layer, a holding layer between the two reinforcement layers. The holding layer is in contact either with the inner face of the anti-wear layer or with the outer face thereof.

When the pipe comprises a plurality of anti-wear layers, the two anti-wear layers can be either identical or different (e.g., there can be two distinct polypropylene homopolymers in each anti-wear layer, or else the dimensions of the strips are either identical or different).

The flexible pipe is generally tubular.

Advantageously, the flexible pipe is of the unbonded type, i.e. the reinforcement layers thereof, such as the tensile armor layer(s) and/or the pressure vault, are unbonded to the adjacent polymeric layer(s), such as the anti-wear layer(s) and/or the inner polymeric sealing sheath and/or the outer polymeric sealing sheath and/or the anti-buckling sheath and/or any tubular polymeric layer forming the flexible pipe.

Preferentially, the flexible pipe is of the unbonded type as described in API 17J (2014) and/or API RP 17B (2014).

Typically, the pipe comprises (or even consists of), from the inside to the outside:
if appropriate, a metal carcass,
an inner polymeric sealing sheath,
if appropriate, a pressure vault as a reinforcement layer,
an inner tensile armor layer as a reinforcement layer,
an outer tensile armor layer as a reinforcement layer,
if appropriate, a reinforcement tape as a reinforcement layer,
an outer polymeric sealing sheath,
   the pipe comprising at least one anti-wear layer as defined hereinabove between two reinforcement layers, i.e. the pipe comprises an anti-wear layer as defined hereinabove:
between the inner tensile armor layer and the outer tensile armor layer, and/or
between the pressure vault and the inner tensile armor layer (with the proviso that the pressure vault is then present),
   and/or,
between the outer tensile armor layer and the reinforcement tape (with the proviso that the reinforcement tape is then present).

In a first embodiment of the first alternative, the at least two reinforcement layers of the pipe comprise at least two tensile armor layers and the anti-wear layer is located between two successive tensile armor layers. The flexible pipe then typically comprises, (or even consists of), from the inside to the outside of the pipe:
if appropriate, a metal carcass,
an inner polymeric sealing sheath,
if appropriate, a pressure vault as a reinforcement layer,
an inner tensile armor layer as a reinforcement layer,
the anti-wear layer as defined hereinabove,
an outer tensile armor layer as a reinforcement layer,
if appropriate, a reinforcement tape as a reinforcement layer, and
an outer polymeric sealing sheath.

The flexible pipe can comprise one or a plurality of additional anti-wear layers as defined hereinabove, in particular between the pressure vault and the inner tensile armor layer (with the proviso that the pressure vault is then present) and/or between the outer tensile armor layer and the reinforcement tape (with the proviso that the reinforcement tape is then present).

In a second embodiment of the first alternative, the at least two reinforcement layers of the pipe comprise at least one layer of tensile armor and a pressure vault and the anti-wear layer is located between the layer of tensile armor (the innermost when there is a plurality of tensile armor layers) and the pressure vault. The flexible pipe then typically comprises (or even consists of), from the inside to the outside of the pipe:
if appropriate, a metal carcass,
an inner polymeric sealing sheath,
a pressure vault as a reinforcement layer,
the anti-wear layer as defined hereinabove,
one, usually two, tensile armor layer(s) as reinforcement layer(s),
if appropriate, a reinforcement tape as a reinforcement layer, and
an outer polymeric sealing sheath.

The flexible pipe can comprise one or a plurality of additional anti-wear layers as defined hereinabove, in particular between two successive tensile armor layers and/or between the tensile armor layer (the outermost when there is a plurality) and the reinforcement tape (with the proviso that the reinforcement tape is then present).

In a third embodiment of the first alternative, the at least two reinforcement layers of the pipe comprise at least one layer of tensile armor and a reinforcement tape and the anti-wear layer is located between the layer of tensile armor (the outermost when there is a plurality of tensile armor layers) and the reinforcement tape.

The flexible pipe then typically comprises (or even consists of), from the inside to the outside of the pipe:
if appropriate, a metal carcass,
the inner polymeric sealing sheath,
if appropriate, a pressure vault as a reinforcement layer,
one, usually two, tensile armor layer(s) as reinforcement layer(s),
an anti-wear layer as defined hereinabove,
a reinforcement tape as a reinforcement layer, and
an outer polymeric sealing sheath.

The flexible pipe can comprise one or a plurality of additional anti-wear layers as defined hereinabove, in particular between two successive tensile armor layers and/or between the pressure vault and the tensile armor layer (the innermost layer when there is a plurality of) (with the proviso that the pressure vault is then present).

In a second alternative, the flexible pipe is a so-called “hybrid” flexible pipe. Same includes (or even consists of), from the inside to the outside:
a tubular inner sheath,
a composite reinforcement structure as a reinforcement layer, the composite reinforcement structure being bonded to the tubular inner sheath, the composite reinforcement structure comprising a winding of at least one laminated reinforcement layer, each reinforcement layer having a fiber-reinforced thermoplastic matrix,
at least one sealing layer of thermoplastic material applied around the composite reinforcement,
an inner tensile armor layer as a reinforcement layer, the inner tensile armor layer not being bonded to the sealing layer,
an outer tensile armor layer as a reinforcement layer,
if appropriate, a reinforcement tape as a reinforcement layer, and
if appropriate, an outer polymeric sealing sheath,
   the pipe comprising at least one anti-wear layer as defined hereinabove between two reinforcement layers, i.e. the pipe comprises an anti-wear layer as defined hereinabove:
between the composite reinforcement structure and the inner tensile armor layer (the wear layer generally surrounding the sealing layer), and/or
between the inner tensile armor layer and the outer tensile armor layer, and/or
between the outer tensile armor layer and the reinforcement tape (with the proviso that the reinforcement tape is then present).

The tubular inner sheath is intended for confining, generally in a sealed way, the transported fluid. The tubular sheath also has the function of protecting the composite reinforcement structure against abrasion associated with the presence of abrasive particles, e.g. sand, within the transported fluid.

The tubular inner sheath is formed of a polymeric material, preferentially a thermoplastic material. For example, the polymer forming the tubular sheath is chosen amongst a polyolefin such as polyethylene, a polyamide such as PA11 or PA12, a fluorinated polymer such as polyvinylidene fluoride (PVDF) or further copolymers of polyvinylidene fluoride and or poly(vinylidene fluoride-co-hexafluoropropylene) (PVDF-HFP), PEK (polyether ketone), PEEK (polyether ether ketone), PEEKK (polyether ether ketone ketone), PEKK (polyether ether ketone ketone), PEKEKK (polyether ketone ether ketone ketone), PAI (polyamide-imide), PEI (polyetherimide), PSU (polysulfone), PPSU (polyphenylsulfone), PES (polyethersulfone), PAS (polyarylsulfone), PPE (polyphenylene ether), PPS (polyphenylene sulfide), LCP (liquid crystal polymers), PPA (polyphthalamide), copolymers thereof, and/or mixtures thereof, or further a mixture of one or a plurality thereof with a polysiloxane, PTFE (polytetrafluoroethylene) or PFPE (perfluoropolyether).

The tubular inner sheath consisting of a polymer tube, a strip of assembled polymer material, or an impregnated polymer mat.

When the tubular inner sheath inner consists of a tube, same is advantageously obtained by extrusion of a thermoplastic tube chosen in particular from the polymers mentioned hereinabove.

When the tubular inner sheath formed by a strip of assembled polymer material, same is advantageously produced by extrusion and winding of thermoplastic strips of a polymer as described hereinabove. Preferentially, the turns of a first layer are contiguous (edge to edge without overlap) and the turns of an upper layer are arranged so as to have an overlap of two adjacent lower strips ensuring the sealing of the tubular inner sheath.

The thickness of the tubular inner sheath is comprised e.g. between 1 mm and 20 mm.

The composite reinforcement structure includes at least one, preferentially a plurality of laminated reinforcement layers, and optionally, an anti-delamination layer interposed between at least two reinforcement layers.

Each laminated reinforcement layer has an overlay of composite reinforcement layers.

Each reinforcement layer includes a polymer matrix and reinforcement fibers embedded in the polymer matrix.

The polymer of the matrix is preferentially thermoplastic. For example, the polymer forming the matrix is chosen amongst a polyolefin such as polyethylene, a polyamide such as PA11 or PA12, a fluorinated polymer such as polyvinylidene fluoride (PVDF) or copolymers of polyvinylidene fluoride and or poly(vinylidene fluoride-co-hexafluoropropylene) (PVDF-HFP), PEK (polyether ketone), PEEK (polyether ether ketone), PEEKK (polyether ether ketone ketone), PEKK (polyether ether ketone ketone), PEKEKK (polyether ketone ether ketone ketone), PAI (polyamide-imide), PEI (polyetherimide), PSU (polysulfone), PPSU (polyphenylsulfone), PES (polyethersulfone), PAS (polyarylsulfone), PPE (polyphenylene ether), PPS (polyphenylene sulfide), LCP (liquid crystal polymers), PPA (polyphthalamide), copolymers thereof, and/or mixtures thereof, or further a mixture of one or a plurality thereof with a polysiloxane, PTFE (polytetrafluoroethylene) or PFPE (perfluoropolyether).

The reinforcement fibers are e.g. carbon fibers, glass fibers, aramid fibers, and/or basalt fibers.

For each of the reinforcement layers, the reinforcement fibers are e.g. unidirectionally arranged in the matrix. Same are then parallel to each other. In a variant, the reinforcement fibers cross over along two orthogonal directions, or else are arranged randomly in the matrix.

The length of the reinforcement fibers in each reinforcement layer is greater than 100 m, and is in particular comprised between 100 m and 4500 m.

The diameter of the composite fibers is e.g. less than 100 microns, and is in particular comprised between 4 microns and 10 microns.

Preferentially, each reinforcement layer is formed by a winding of at least one composite strip having a plurality of layers of fibers embedded in an elongated matrix with a length greater than at least 10 times the width thereof and at least 10 times the thickness thereof.

E.g. the length of each composite strip is greater than 100 m and is comprised between 100 m and 4500 m. The width of each composite strip is comprised between 6 mm and 50 mm. The thickness of each composite strip is comprised between 0.1 mm and 1 mm.

During the production of each reinforcement layer, the or each composite strip is wound helically about the inner tubular sheath, and is heated so as to lead to the partial melting of the matrix, and the bonding with the successive turns of the composite strip, and/or with the adjacent layers which can be other reinforcement layers, anti-delamination layers or the tubular inner sheath.

The absolute value of the winding helix angle β of each composite strip with respect to the axis of the pipe is comprised e.g. between 55° and 85°. The above ensures an elongation of the composite under the effect of the inner pressure, and a suitable cooperation with the armor layers.

The thickness of reinforcement layer is generally comprised between 0.10 mm and 10 mm, e.g. between 0.12 mm and 7 mm, or between 0.22 mm and 5 mm.

The sealing layer is intended for confining the composite reinforcement structure in a leaktight way. More particularly, and in the event of water infiltration inside the flexible pipe, between the outer polymeric sheath and the sealing layer, the function of the layer 22 is to limit, preferentially to prevent, a contact between the infiltrated water and the composite reinforcement structure.

The sealing layer preferentially comprises a thermoplastic polymer. For example, the polymer forming the sealing layer is chosen from a polyolefin, if appropriate cross-linked, such as polyethylene or polypropylene; a thermoplastic elastomer (TPE) such as thermoplastic polyurethane (TPE-U or TPU) or styrene copolymers (TPE-S or TPS) or vulcanized (TPE-V or TPV) polypropylene-ethylene-propylene-diene copolymers (PP-EPDM); a polyamide such as PA11 or PA12; or a fluorinated polymer such as polyvinylidene fluoride (PVDF) or further copolymers of polyvinylidene fluoride and or poly(vinylidene fluoride-co-hexafluoropropylene) (PVDF-HFP), or same comprises a polymer chosen from PEK (polyether ketone), PEEK (polyether ether ketone), PEEKK (polyether ether ketone), PEKEK (polyether ketone), PEEK (polyether ketone), PEEK (polyether ketone), polyether ketone) PAI (polyamide-imide), PEI (polyether-imide), PSU (polysulfone), PPSU (polyphenylsulfone), PES (polyethersulfone), PAS (polyarylsulfone), PPE (polyphenylene ether), PPS (polyphenylene sulfide), LCP (liquid crystal polymers), PPA (polyphthalamide) and/or mixtures thereof or further a mixture of one or plurality thereof with a polysiloxane, PTFE (polytetrafluoroethylene) or PFPE (perfluoropolyether).

The sealing layer can be a one-piece tubular sheath obtained by extruding a thermoplastic material around the composite reinforcement structure. In a variant, the sealing layer is made from a discontinuous structure, e.g. a strip of assembled polymer material. Same is then typically produced by winding thermoplastic strips of a thermoplastic polymer, followed by a step of welding the thermoplastic strips. Preferentially, the turns of a first layer are contiguous (edge to edge without overlap) and the turns of an upper layer are arranged so as to have an overlap of two adjacent lower strips ensuring the sealing of the sealing layer.

The sealing layer can be bonded or unbonded to the composite reinforcement structure.

The embodiments described hereinabove for the tensile armor layer(s) of the pipe according to the first alternative are applicable to the tensile armor layers of the pipe according to the second alternative.

The embodiments described hereinabove for the reinforcement tape of the pipe according to the first alternative are applicable to the reinforcement tape of the pipe according to the second alternative.

The embodiments described hereinabove for the outer polymeric pipe sealing sheath according to the first alternative are applicable for the outer polymeric pipe sealing sheath according to the second alternative.

The anti-wear layer can be adjacent to and located between the two reinforcement layers. In such case, the anti-wear layer is the only layer between the two reinforcement layers.

Alternatively, there can be one or a plurality of other layers between the two reinforcement layers. For example, there can be, in addition to the anti-wear layer, a holding layer between the two reinforcement layers. The holding layer is in contact either with the inner face of the anti-wear layer or with the outer face thereof.

In a first embodiment of the second alternative, the at least two reinforcement layers of the pipe comprise at least two tensile armor layers and the anti-wear layer is located between two successive tensile armor layers. The flexible pipe then typically comprises, (or even consists of), from the inside to the outside of the pipe:
a tubular inner sheath,
a composite reinforcement structure as a reinforcement layer, the composite reinforcement structure being bonded to the tubular inner sheath, the composite reinforcement structure comprising a winding of at least one laminated reinforcement layer, each reinforcement layer having a fiber-reinforced thermoplastic matrix,
at least one sealing layer of thermoplastic material applied around the composite reinforcement,
an inner tensile armor layer as a reinforcement layer, the inner tensile armor layer not being bonded to the sealing layer,
an anti-wear layer as defined hereinabove,
an outer tensile armor layer as a reinforcement layer,
if appropriate, a reinforcement tape as a reinforcement layer, and
if appropriate, an outer polymeric sealing sheath,

The flexible pipe can comprise an additional anti-wear layer as defined hereinabove, in particular between the composite reinforcement structure and the inner tensile armor layer and/or between the outer tensile armor layer and the reinforcement tape (with the proviso that the reinforcement tape is then present).

In second embodiment of second alternative, the at least two reinforcement layers of the pipe comprise at least one layer of tensile armor and a reinforcement tape and the anti-wear layer is located between the layer of tensile armor (the outermost when there is a plurality of tensile armor layers) and the reinforcement tape.

The flexible pipe then typically comprises (or even consists of), from the inside to the outside of the pipe:
a tubular inner sheath,
a composite reinforcement structure as a reinforcement layer, the composite reinforcement structure being bonded to the tubular inner sheath, the composite reinforcement structure comprising a winding of at least one laminated reinforcement layer, each reinforcement layer having a fiber-reinforced thermoplastic matrix,
at least one sealing layer of thermoplastic material applied around the composite reinforcement,
an inner tensile armor layer as a reinforcement layer, the inner tensile armor layer not being bonded to the sealing layer,
an outer tensile armor layer as a reinforcement layer,
an anti-wear layer as defined hereinabove,
a reinforcement tape as a reinforcement layer, and
if appropriate, an outer polymeric sealing sheath,

The flexible pipe can comprise an additional anti-wear layer as defined hereinabove, in particular between the composite reinforcement structure and the inner tensile armor layer and/or between two successive tensile armor layers.

In a third embodiment of the second alternative, the at least two reinforcement layers of the pipe comprise a composite reinforcement structure and at least one layer of tensile armor and the anti-wear layer is located between the reinforcement structure and the tensile armor layer (the innermost when there is a plurality of tensile armor layers).

The flexible pipe then typically comprises (or even consists of), from the inside to the outside of the pipe:
a tubular inner sheath,
a composite reinforcement structure as a reinforcement layer, the composite reinforcement structure being bonded to the tubular inner sheath, the composite reinforcement structure comprising a winding of at least one laminated reinforcement layer, each reinforcement layer having a fiber-reinforced thermoplastic matrix,
at least one sealing layer of thermoplastic material applied around the composite reinforcement,
an anti-wear layer as defined hereinabove
an inner tensile armor layer as a reinforcement layer, the inner tensile armor layer not being bonded to the sealing layer,
an outer tensile armor layer as a reinforcement layer,
if appropriate, a reinforcement tape as a reinforcement layer, and
if appropriate, an outer polymeric sealing sheath,

The flexible pipe can comprise an additional anti-wear layer as defined hereinabove, in particular between two successive layers of tensile armors and/or between the outer layer of tensile armors and the reinforcement tape (with the proviso that the reinforcement tape is then present).

According to a second subject matter, the invention relates to a method for preparing a flexible underwater pipe for the transport of fluid, preferentially of hydrocarbons, in particular as defined hereinabove, comprising the helically winding in sequence of at least two longitudinal elements made of metal or composite material, in order to form at least two reinforcement layers, at least one strip of polymeric material being helically wound between said reinforcement layers in order to form an anti-wear layer, the polymeric material comprising a polypropylene homopolymer having:
a flexural modulus measured at 23° C., according to the 2019 ISO 178 standard, greater than 1500 MPa, and
a melt flow index measured as per ISO 1133, revised in 2011, at 230° C. under a weight of 2.16 kg less than or equal to 4.0 g/10 minutes.

The embodiments defined hereinabove for the flexible pipe are of course applicable for the method. Preferentially, the flexible pipe prepared by the method is same as defined hereinabove.

The method can comprise a prior or simultaneous step of preparation of the at least one strip, by extrusion. The polypropylene homopolymer defined hereinabove has the advantage of being extruded easily. Generally, the polypropylene homopolymer (or the mixture thereof) is extruded in the form of long, thin sheets, the latter are then split in order to obtain the strips of desired width (from 30 to 200 mm, preferentially from 40 to 150 mm, typically of 40, 75, 100 or 126 mm). In an alternative, the polypropylene homopolymer (or the mixture thereof) is extruded directly in the form of a strip having the desired width. The strips are then packed for being installed on a pipe production system.

The strips can be butted together, typically by welding, in particular by ultrasound, by laser, or by covering and then heating, e.g. by contact with a heating plate until melting, or by bonding (with an glue, an adhesive tape or an adhesive).

According to a third subject matter, the subject matter of the invention is an underwater pipe which can be obtained by the aforementioned method.

According to a fourth subject matter, the invention relates to the use of the aforementioned underwater pipe for the transport of fluid, preferentially of hydrocarbons.

The flexible pipe can be used at great depths, typically down to a depth of 3000 meters. The pipe can be used for the transport of fluids, preferentially hydrocarbons, having a temperature greater than 90° C., typically reaching 130° C. and which can even exceed 150° C. and/or an inner pressure greater than 100 bar, which can reach 1000 bar, or even 1500 bar.

According to a fifth subject matter, the invention relates to the use of a polypropylene homopolymer (or a mixture of polypropylene homopolymers), where said polypropylene homopolymer (or said mixture) has:
a flexural modulus measured at 23° C., according to the 2019 ISO 178 standard, greater than 1500 MPa, and
a melt flow index measured as per ISO 1133, revised in 2011, at 230° C. under a weight of 2.16 kg less than or equal to 4.0 g/10 minutes,
   as a polymeric material of a helically wound strip to form a localized anti-wear layer between at least two reinforcement layers of an underwater pipe intended for the transport of fluids, preferentially of hydrocarbons, each of said reinforcement layers being produced by helically winding a longitudinal metallic or composite material element, in order to improve the creep resistance of said anti-wear layer.

The invention further relates to a method for improving the creep resistance of an anti-wear layer of polymeric material which separates at least two reinforcement layers of a flexible underwater pipe for the transport of fluids, preferentially of hydrocarbons, each of said reinforcement layers (12, 16, 20) being produced by helical winding of a longitudinal element of metal or of composite material, said anti-wear layer being produced by helical winding of at least one strip of said polymeric material, the method comprising the use of a polypropylene homopolymer as defined hereinabove within said polymeric material.

Such improvement of the creep resistance shows as a small loss of thickness of the anti-wear layer, preferentially of less than 60%, in particular of less than 50%, in particular of less than 40%, after 20 years of use of the flexible pipe at a temperature of 90° C. and a pressure of 200 bar, or further at a temperature of 70° C. and a pressure of 300 bar.

Of course, the embodiments described hereinabove are applicable.

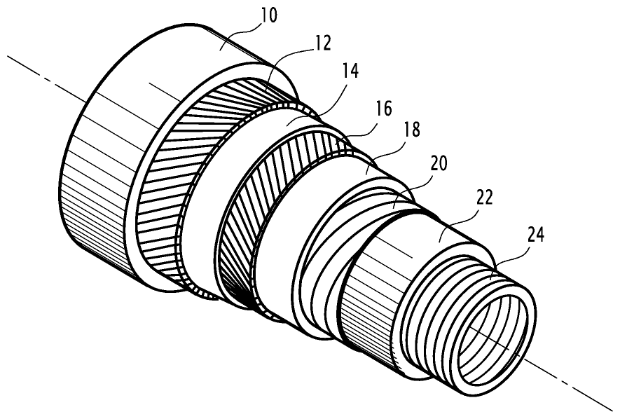

Other features and advantages of the invention will appear upon reading the description given hereinafter of the embodiments of the invention, given only as an example, but not limited to, and making reference to FIG. 1.

FIG. 1 is a partial, schematic perspective schematic view of a flexible pipe according to a first embodiment of the invention. Same illustrates a pipe according to the invention comprising (or even consisting of), from the outside towards the inside:
an outer polymeric sealing sheath 10,
an outer layer of tensile armors 12 produced by helical winding, with a long pitch, of a longitudinal element of metal or of composite material,
a first anti-wear layer 14 produced by helical winding of at least one strip of a polymeric material comprising a polypropylene homopolymer such as defined hereinabove,
an inner layer of tensile armors 16 produced by helical winding, with a long pitch, of a longitudinal element of metal or of composite element (in the opposite direction to the helical winding of the longitudinal element of the outer layer of tensile armors 12),
a second anti-wear layer 18 produced by helical winding of at least one strip of a polymeric material comprising a polypropylene homopolymer such as defined hereinabove,
a pressure vault 20 produced by helical winding, with a short pitch, of a longitudinal element,
an inner polymeric sealing sheath 22, and
an inner carcass 24 for taking up radial crushing forces.

The pipe shown has a first helical winding of a strip of a polymeric material comprising a polypropylene homopolymer such as defined hereinabove in order to form a first anti-wear layer 14 between the two tensile armor layers 12, 16 and a second helical winding of a strip of polymeric material comprising a polypropylene homopolymer as defined hereinabove in order to form a second anti-wear layer 18 between the pressure vault 20 and the inner layer of tensile armors 16.

By means of the two anti-wear layers, the tensile armor layers 12, 16 and the pressure vault 20 are not in contact with each other, so that, during the bending of the flexible pipe, there is no wear due to the friction of the reinforcement layers against each other.

Because of the presence of the inner carcass 24, the pipe is called a rough-bore pipe. The invention could also be applied to a so-called smooth-bore pipe which does not include an inner carcass.

The invention could be applied to a pipe not comprising the first anti-wear layer 14 (the pipe then necessarily comprises the anti-wear layer 18). The invention could also be applied to a pipe not comprising the second anti-wear layer 18 (the pipe then necessarily comprises the first anti-wear layer 14).

Likewise, removing the pressure vault 20 and the anti-wear layer 18 would mean departing from the scope of the present invention.

In FIG. 1, only two tensile armor layers 12 and 16 are shown, but the pipe could also include one or a plurality of additional pairs of tensile armors. The anti-wear layer can then be present between two successive armor layers. There can also be an anti-wear layer between each of the armor layers. For example, if there are four armor layers, the pipe can comprise, from the outside towards the inside, an outermost armor layer, a first anti-wear layer such as defined hereinabove, an outer intermediate armor layer, a second anti-wear layer such as defined hereinabove, an inner intermediate armor layer, a third anti-wear layer such as defined hereinabove, an innermost layer of armors, the first, second and third anti-wear layers being either identical to each other or different.

The flexible pipe can also comprise layers not shown in FIG. 1, such as a holding layer, e.g. between the outer polymeric sheath 10 and the outer tensile armor layer 12, or between two tensile armor layers 12 and 16, or else in contact either with the inner face of the anti-wear layer 14 or with the outer face thereof.

### EXAMPLE

### Example 1: Preparation of Polymer Sheets by Extrusion

Polymer samples were extruded at a speed of 3.3 to 3.9 m/minute in the form of strips with a width on the order of 100 mm, a thickness on the order of 1.5 mm and a length of at least 20 meters.

TABLE 1
Features of extruded polymers in strip form.

| | | | | | | Flexural | melting | | |
|---|---|---|---|---|---|---|---|---|---|
| | | | | MFI | | modulus at | temperature | | |
| | | | | (g/10 min) | Modulus of | 23° C. | ISO | Degree of | Degree of |
| | | | | 230° C./ | elasticity | (MPa) | 11357-3) | crystallinity | crystallinity |
| | Polymer | Supplier | Grade | 2.16 kg | (MPa) | (ISO 178) | (° C.) | (1^{st} heating) | (2^{nd} heating) |
| Comp. | Propylene | Total | PPC | 0.3 | 1800 as per | — | 228 | 57 | 64 |
| | copolymer | | 1645 | | ISO 527-2; | | | | |
| | | | | | (1819) as per | | | | |
| | | | | | ASTM D638 | | | | |
| | | | | | type IV. | | | | |
| Comp. | Propylene | INEOS | ELTEX | 0.3 | (1520) as per | 1850 | 227 | 55 | 63 |
| | copolymer | | Tub 350- | | ASTM D638 | | | | |
| | | | HM00 | | type IV. | | | | |
| Inv. | Polypropylene | Repsol | PP040 | 3 | (1935) as per | 1800 | 227 | 64 | 71 |
| | homopolymer | | C1E | | ASTM D638 | | | | |
| | | | | | type IV. | | | | |
| Inv. | Polypropylene | Total | PPH4022 | 3 | 1800 as per | 1700 | 226 | 56 | 67 |
| | homopolymer | | | | ISO 527-2; | | | | |
| | | | | | 1939 as per | | | | |
| | | | | | ASTM D638 | | | | |
| | | | | | type IV. | | | | |
| Inv. | Polypropylene | Polychim | HL10XF | 3.9 | (1666) as per | 1800 | 236 | 55 | 61 |
| | homopolymer | | | | ASTM D638 | | | | |
| | | | | | type IV. | | | | |
| Comp. | Polypropylene | SABIC | 520P | 10 | (1800) as per | — | 200 | ND | ND |
| | homopolymer | | | | ASTM D638 | | | | |
| | | | | | type IV. | | | | |

Comp.: comparative -
Inv.: Polypropylene homopolymer as defined in the invention
*Degree calculated by dividing the heat of fusion of the polymer obtained by DSC with heating up to 200° C. at 20° C./minute by the heat of fusion of a 100% crystalline polypropylene homopolymer estimated at 207 joules/grams (Perkin Elmer documentation)

Due to the high melt flow index (10 g/10 min), the extrusion of SABIC polypropylene homopolymer led to a strip with not very homogeneous thickness and width.

### Example 2: Creep Testing

The creep testing consisted in placing a disk of the polymer material (60 mm in diameter and with the same thickness as the strip used on a flexible pipe: 0.8 mm, 1.5 mm, 2.5 mm, etc.) between two steel pieces, also circular, with the same diameter as the strip, and machined so as to reproduce on the face in contact with the strip, the dimensions and clearances (separated) of the wires of pressure vaults and armor layers. For example, to simulate an armor layer/armor layer interface with wires of 14 mm (width)×6 mm (height), the clearance is 0.7 mm. To simulate an armor layer/pressure vault interface, a clearance of 3.5 mm was used on one side and 0.7 mm on the other side.

The steel part/polymer disc/steel part assembly was placed under pressure and temperature and the thickness loss of the strip was measured. The test lasted between a few hours and several months, the aim being to observe the stabilization of the “creep rate” (i.e. the slope of the loss of thickness of the polymer disc as a function of time).

The results of loss of thickness after 200 hours of testing are given in Table 2 and correspond to a configuration with a clearance of 3.5 mm on one side and 0.7 mm on the other side (which simulates an armor sheet/pressure vault interface). Since almost all of the thickness loss of an anti-wear layer takes place at the very beginning of the commissioning of the flexible pipe, 200 hours of testing are sufficient for evaluating the creep resistance.

TABLE 2
Thickness losses after 200 hours of testing at 90°
C. and 200 bar depending on the polymer tested.

| | PP copolymer | | PP homopolymer |
|---|---|---|---|
| | (Total | PVDF | (Repsol |
| Loss of thickness | PPC1645) | (CoflonXD) | PP040C1E) |
| after 200 hours | (comparative) | (comparative) | (invention) |
| 90° C./200 bar | 80.3% | 91.2% | 49.6% |

The results show that the loss of thickness is much less for polypropylene homopolymer with a flexural modulus and a melt flow index as required. The loss of thickness with the PP copolymer is 62% greater than the loss observed with the PP homopolymer and, and the loss of thickness with the PVDF is 84% greater than the loss observed with the PP homopolymer.

1. A flexible underwater pipe for the transport of fluid comprising at least two reinforcement layers separated by an anti-wear layer of polymeric material, each of said reinforcement layers being produced by helical winding of a longitudinal element of metal or of composite material, said anti-wear layer being produced by helical winding of at least one strip of said polymeric material, the polymeric material comprising a polypropylene homopolymer having:
a flexural modulus measured at 23° C., according to the 2019 ISO 178 standard, greater than 1500 MPa, and
a melt flow index measured as per ISO 1133, revised in 2011, at 230° C. under a weight of 2.16 kg less than or equal to 4.0 g/10 minutes.

2. The flexible pipe according to claim 1, wherein the polypropylene homopolymer has a flexural modulus measured at 23° C., as per the 2019 ISO 178 standard, of greater than or equal to 1550 MPa.

3. The flexible pipe according to claim 1 wherein the polypropylene homopolymer has:
a density measured as per ISO 1183 of 2019 greater than or equal to 0.85 g/cm³,
a tensile stress at the threshold measured at 23±2° C. and with a displacement speed of 50 mm/minute according to ASTM D638 of 2014 or ISO 527-2 of 2012 comprised between 30 and 45 MPa,
an elongation at yield measured at 23±2° C. as per ASTM D638 of 2014 or ISO 527-2 of 2012, of 1 to 7%,
a melting temperature determined by differential scanning calorimetry as per the 2018 ISO 11357-3 standard at least equal to 150° C., and/or
a degree of crystallinity determined by differential scanning calorimetry of at least 40%.

4. The flexible pipe according to claim 1, wherein the strip comprises less than 0.4% of plastomer formed from propylene and at least one comonomer other than propylene.

5. The flexible pipe according to according to claim 1, wherein the strip comprises, or even consists of:
80 to 100% by weight of polypropylene homopolymer having:
a flexural modulus measured at 23° C., according to the 2019 ISO 178 standard, greater than 1500 MPa, and
a melt flow index measured as per ISO 1133, revised in 2011, at 230° C. under a weight of 2.16 kg less than or equal to 4.0 g/10 minutes,
0 to 5% by weight of plasticizer,
0 to 5% by weight of impact modifier,
0 to 10% by weight of additives.

6. The flexible pipe according to claim 1, which comprises from the inside to the outside:
if appropriate, a metal carcass,
an inner polymeric sealing sheath,
if appropriate, a pressure vault,
an inner tensile armor layer,
an outer tensile armor layer,
if appropriate, a reinforcement tape,
an outer polymeric sealing sheath,
the pipe comprising an anti-wear layer of polymeric material and being produced by helical winding of at least one strip of said polymeric material, the polymeric material comprising a polypropylene homopolymer having:
a flexural modulus measured at 23° C., according to the 2019 ISO 178 standard, greater than 1500 MPa, and
a melt flow index measured as per ISO 1133, revised in 2011, at 230° C. under a weight of 2.16 kg less than or equal to 4.0 g/10 minutes,
said anti-wear layer being:
between the inner tensile armor layer and the outer tensile armor layer and/or
between the pressure vault and the inner tensile armor layer and, and/or
between the outer tensile armor layer and the reinforcement tape.

7. The flexible pipe according to claim 6, the flexible pipe being of the unbonded type.

8. The flexible pipe according to claim 1, which comprises from the inside to the outside:
a tubular inner sheath,
a composite reinforcement structure bonded to the tubular inner sheath, the composite reinforcement structure comprising a winding of at least one laminated reinforcement layer, each reinforcement layer having a fiber-reinforced thermoplastic matrix,
at least one sealing layer of thermoplastic material applied around the composite reinforcement,
an inner tensile armor layer unbonded to the sealing layer,
an outer tensile armor layer,
if appropriate, a reinforcement tape, and
if appropriate, an outer polymeric sealing sheath,
the pipe comprising an anti-wear layer of polymeric material and being produced by helical winding of at least one strip of said polymeric material, the polymeric material comprising a polypropylene homopolymer having:
a flexural modulus measured at 23° C., according to the 2019 ISO 178 standard, greater than 1500 MPa, and
a melt flow index measured as per ISO 1133, revised in 2011, at 230° C. under a weight of 2.16 kg less than or equal to 4.0 g/10 minutes,
said anti-wear layer being:
between the composite reinforcement structure and the inner tensile armor layer, and/or
between the inner tensile armor layer and the outer tensile armor layer and/or
between the outer traction armor layer and the reinforcement tape.

9. A method of preparation of a flexible underwater pipe for the transport of fluid, comprising the helical winding in sequence of at least two longitudinal elements of metal or of composite material, in order to form at least two reinforcement layers, at least one strip of polymeric material being helically wound between said reinforcement layers in order to form an anti-wear layer, the polymeric material comprising a polypropylene homopolymer having:
a flexural modulus measured at 23° C., according to the 2019 ISO 178 standard, greater than 1500 MPa, and
a melt flow index measured as per ISO 1133, revised in 2011, at 230° C. under a weight of 2.16 kg less than or equal to 4.0 g/10 minutes.

10. A method for the transport of a fluid comprising transporting the fluid in the submarine pipeline according to claim 1.

11. (canceled)

12. A method for the transport of a fluid comprising transporting the fluid in the submarine pipeline obtained by the method of claim 9.
